(19) United States
(12) Patent Application Publication
(10) Pub. No.: US 2026/0217474 A1
(43) Pub. Date: Jul. 30, 2026

(54) CONVEYANCE TASK MANAGEMENT SYSTEM AND CONVEYANCE TASK MANAGEMENT METHOD

(71) Applicant: Hitachi, Ltd., Tokyo (JP)

(72) Inventors: Azuma OKUNO, Tokyo (JP); Kiyoto ITO, Tokyo (JP); Rui NING, Tokyo (JP)

(21) Appl. No.: 19/151,776

(22) PCT Filed: Mar. 7, 2024
(86) PCT No.: PCT/JP2024/008765

§ 371 Date: Jul. 29, 2025

(30) Foreign Application Priority Data
Apr. 3, 2023 (JP) 2023-060014

(51) Int. Cl. B65G 43/00; B25J 9/00; B25J 9/16

(52) U.S. Cl. CPC B65G 43/00; B25J 9/0084; B25J 9/1664; B25J 9/1671

(57) ABSTRACT

The present invention provides a conveyance task management system capable of reducing conveyance delays even if conveyance times by conveyance robots vary. A conveyance task management system according to the present invention comprises: a conveyance information reception unit (110) for inputting task information regarding conveyance tasks and robot information regarding robots; a delay risk calculation unit (111) that calculates a delay risk, which is the probability that a conveyance task by a robot will be delayed; a task allocation unit (112) that executes a task allocation process, which is a process for allocating robots included in the robot information to conveyance tasks included in the task information so that delay risks are minimized; and a result output unit (113) that outputs the task allocation results.

### TECHNICAL FIELD

The present invention relates to a management system and a management method of a conveyance task by a plurality of conveyance robots.

### BACKGROUND ART

In a manufacturing factory or a physical distribution warehouse, the automation of conveyance by a conveyance robot such as an AGV (Automated Guided Vehicle) or an AMR (Automated Vehicle) is progressing. Accordingly, the research and development have been conducted on the management of conveyance tasks so that each article can be efficiently conveyed by a minimum number of robots. Examples of a conventional management system and method for conveyance tasks have been described in Patent Literature 1 and Patent Literature 2.

The conveyance management system described in Patent Literature 1 includes a reception unit which receives p pieces of conveyance task information each indicating a conveyance task having a start point and an end point, a connection unit which connects the p pieces of conveyance task information to each other to generate q (q<p) pieces of connected task information, and an assignment unit which assigns the q pieces of connected task information to q conveyance moving devices, respectively. The connection unit generates the q pieces of connected task information so that a total movement distance being the sum of movement distances of the q pieces of conveyance moving devices required for the q pieces of conveyance moving devices to execute the q pieces of connected task information respectively is shortened.

The method described in Patent Literature 2 provides optimization of scheduling of non-preemptive tasks in a multi-robot environment by defining a plurality of tasks, merging the plurality of tasks, and implementing an online minimum performance loss scheduling (OMPLS) technique to first schedule a task with a higher performance loss value, then schedule a task with a low performance loss value among the tasks which can be scheduled within the deadline and are merged, and finally minimize performance loss values of the remaining subset of tasks which cannot be scheduled within the predefined deadline.

### CITATION LIST

### Patent Literature

Patent Literature 1: Japanese Unexamined Patent Application Publication No. 2022-134834
Patent Literature 2: Japanese Unexamined Patent Application Publication No. 2020-149675

### SUMMARY OF INVENTION

### Technical Problem

When an article is conveyed by a conveyance robot in a factory or a warehouse, it is important that the conveyance is not delayed. For example, when a conveyance robot is introduced for conveyance between a plurality of assembly lines in a manufacturing factory, it is required that the conveyance is not delayed so as not to affect a production process in a line of a conveyance destination. In particular, when a conveyance robot is introduced into an existing factory, it is difficult to newly secure a movement space dedicated to the conveyance robot, and the movement space of the conveyance robot is shared with a person. When the movement space is shared by the conveyance robot and the person, the conveyance robot is decelerated or temporarily stopped when the person is present around the conveyance robot in order to ensure safety. Therefore, the conveyance time of the conveyance robot may vary or the conveyance may be delayed.

In the related art, for example, in the technology described in Patent Literature 1, the total movement distance of the conveyance robot is shortened to improve conveyance efficiency, but the variation in the conveyance time of the conveyance robot such as described above is not considered, and the delay of conveyance is not considered. Further, in the related art, for example, in the technology described in Patent Literature 2, the task is scheduled so as to minimize the loss caused by the delay exceeding the deadline, but the variation in the conveyance time of the conveyance robot and the probability of occurrence of the delay are not quantitatively evaluated, and the occurrence of the delay cannot be correctly grasped.

Thus, in the related art, the variation in the conveyance time caused due to the sharing of the movement space for the person and the robot and the like is not fully considered, and there is a problem in reducing the delay of conveyance by the conveyance robot.

An object of the present invention is to provide a conveyance task management system and a conveyance task management method capable of reducing a delay in conveyance even when a conveyance time by a conveyance robot varies.

### Solution to Problem

A conveyance task management system of the present invention includes: a conveyance information reception unit configured to input task information related to a conveyance task and robot information related to a robot that executes the conveyance task; a delay risk calculation unit configured to calculate a delay risk that is a probability that the conveyance task by the robot is delayed; a task assignment unit configured to execute task assignment processing that is processing of assigning the robot included in the robot information to the conveyance task included in the task information so that the delay risk is minimized; and a result output unit configured to output a task assignment result which is a result of the task assignment processing.

A conveyance task management method of the present invention is executed by a conveyance task management system having an arithmetic processing section, and the conveyance task management method includes: a conveyance data input step of inputting by the arithmetic processing section, task information related to a conveyance task and robot information related to a robot that executes the conveyance task; a delay risk calculation step of calculating by the arithmetic processing section, a delay risk that is a probability that the conveyance task by the robot is delayed; a task assignment step of executing by the arithmetic processing section, task assignment processing that is processing of assigning the robot included in the robot information to the conveyance task included in the task information so that the delay risk is minimized; and a result output step of outputting by the arithmetic processing section, a task assignment result that is a result of the task assignment processing.

### Advantageous Effects of Invention

It is possible to provide a conveyance task management system and a conveyance task management method capable of reducing a delay in conveyance even when a conveyance time by a conveyance robot varies.

### BRIEF DESCRIPTION OF DRAWINGS

FIG. 1 is a diagram showing an example of a configuration of a conveyance task management system according to a first embodiment of the present invention.

FIG. 2 is a diagram showing an example of conveyance data.

FIG. 3 is a diagram describing an example of a delay risk, and is a diagram illustrating a probability density distribution of a conveyance time of a conveyance robot.

FIG. 4 is a diagram illustrating an example of a flowchart of processing in which a task assignment unit assigns a conveyance robot to any one task.

FIG. 5A is a diagram illustrating an example in which a result of the task assignment processing is output, and is a diagram illustrating an example of task assignment result data.

FIG. 5B is a diagram illustrating an example of outputting the result of the task assignment processing, and is a diagram illustrating an example of a visualization display 510 of the task assignment result.

FIG. 6 is a diagram illustrating an example of a hardware configuration of the conveyance task management system according to the present embodiment.

FIG. 7 is a diagram illustrating an example of a configuration of a conveyance task management system according to a second embodiment of the present invention.

FIG. 8 is a diagram illustrating an example of a layout of a conveyance area in which a conveyance robot executes a conveyance task.

FIG. 9 is a diagram illustrating an example of a flowchart of processing in which a conveyance simulation execution unit obtains a probability density distribution of a conveyance time using a Monte Carlo method.

FIG. 10 is a diagram for describing an example of a method of estimating the probability density distribution of the conveyance time by the conveyance simulation execution unit.

FIG. 11 is a diagram illustrating an example of a configuration of a conveyance task management system according to a third embodiment of the present invention.

FIG. 12 is a diagram illustrating an example of a configuration of a conveyance task management system according to a fourth embodiment of the present invention.

FIG. 13 is a diagram illustrating an example of a relationship between the number of conveyance robots and an evaluation index obtained by an optimization unit.

FIG. 14 is a diagram illustrating an example of a configuration of a conveyance task management system according to a fifth embodiment of the present invention.

FIG. 15 is a diagram illustrating an example of task execution data.

### DESCRIPTION OF EMBODIMENTS

In a conveyance task management system and a conveyance task management method according to the present invention, for example, even when a conveyance time by a conveyance robot varies because of the conveyance robot sharing its movement space with a person, and the like, a robot can be assigned to a task so as not to cause a delay in the conveyance of an article, and the delay in the conveyance can be reduced.

In the present specification, a task of conveying an article is referred to as a conveyance task or simply as a task. Further, a robot which executes a conveyance task is referred to as a conveyance robot or simply a robot.

Hereinafter, a conveyance task management system and a conveyance task management method according to embodiments of the present invention will be described. The conveyance task management method according to the present embodiment is executed by the conveyance task management system according to the present embodiment. In the following embodiment, a description will be made about an example in which the conveyance task is mainly performed in a manufacturing factory. However, the present invention is applicable to any place where a conveyance task is performed by a conveyance robot, such as a distribution warehouse or a restaurant. Note that in the drawings used in the present specification, the same or corresponding components are denoted by the same reference numerals, and repeated description of these components may be omitted.

### First Embodiment

A conveyance task management system and a conveyance task management method according to a first embodiment of the present invention will be described.

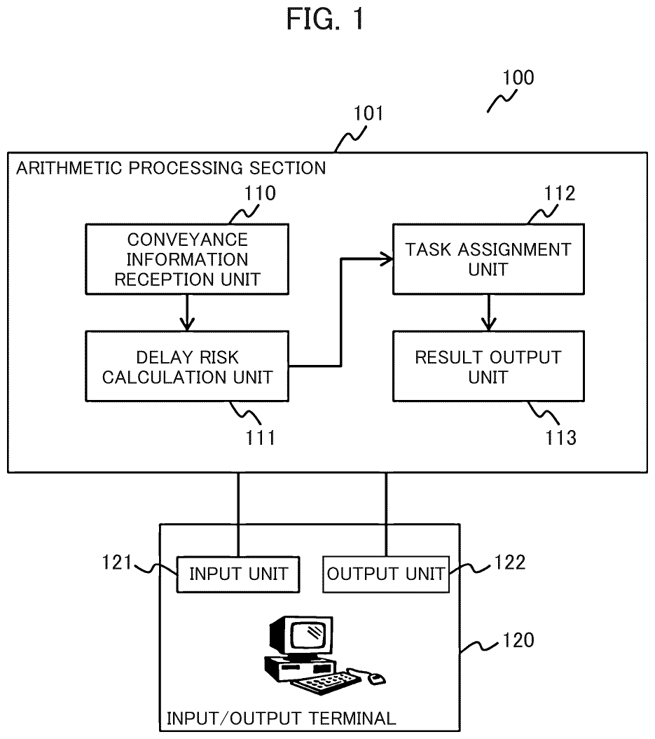

FIG. 1 is a diagram showing an example of a configuration of a conveyance task management system 100 according to the first embodiment of the present invention.

The conveyance task management system 100 can be configured by a computer, and includes an arithmetic processing section 101 and an input/output terminal 120.

The input/output terminal 120 includes an input unit 121 and an output unit 122, and is connected to the arithmetic processing section 101. The input unit 121 is a component for inputting an instruction, data, and the like to the arithmetic processing section 101, and can be configured by a keyboard, a mouse, a touch panel, and the like. The output unit 122 is a component for outputting a calculation result or the like of the arithmetic processing section 101, and can be configured by a device having a screen such as a monitor.

The arithmetic processing section 101 includes a conveyance information reception unit 110, a delay risk calculation unit 111, a task assignment unit 112, and a result output unit 113.

The conveyance information reception unit 110 inputs conveyance data.

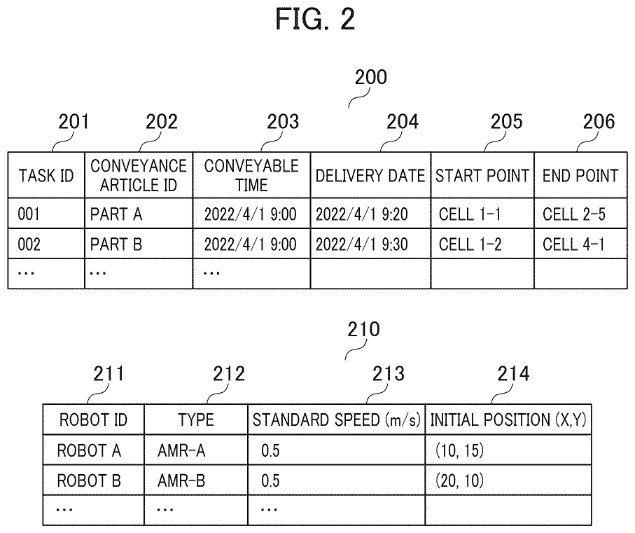

FIG. 2 is a diagram showing an example of conveyance data. The conveyance data includes at least task data 200 and robot data 210.

The task data 200 indicates task information that is information related to a conveyance task, and includes a task ID 201, a conveyance article ID 202, a conveyable time 203, a delivery date 204, a start point 205, and an end point 206. The task data 200 is generated by a higher-level system of the conveyance task management system 100 or a worker, and is input to the arithmetic processing section 101 by the conveyance information reception unit 110. For example, in the case of conveyance in a manufacturing factory, the task data 200 is generated by an MES (Manufacturing Execution System) together with instructions to a manufacturing line.

The task ID 201 is a value which specifies a conveyance task to be executed by the conveyance robot.

The conveyance article ID 202 is a value which specifies an article conveyed by the conveyance robot.

The conveyable time 203 is a time at which the conveyance of the article by the conveyance robot becomes possible, and is, for example, a time at which the article to be conveyed is manufactured and is conveyable. The conveyable time 203 is present in the case of conveyance between facilities which perform processes in a factory, but may not be included in the task data 200 in the case of conveying an article from a component storage or the like. In the present embodiment, a description will be made about an example in which the task data 200 includes the conveyable time 203.

The delivery date 204 is a deadline for the conveyance robot to convey the article.

The start point 205 and the end point 206 are a start point and an arrival point respectively, at which the conveyance robot conveys an article.

The robot data 210 indicates robot information, which is information about a conveyance robot which executes a conveyance task, and includes a robot ID 211, a type 212, a standard speed 213, and an initial position 214. The robot data 210 is, for example, data generated in advance or data input by a worker through the input/output terminal 120, and is input to the arithmetic processing section 101 by the conveyance information reception unit 110.

The robot ID 211 is a value which specifies the conveyance robot.

The type 212 is a value which specifies the type or model of the conveyance robot.

The standard speed 213 is a standard moving speed when the conveyance robot moves.

The initial position 214 represents the initial position of the conveyance robot by coordinates.

In the present embodiment, only the conveyance robot is assumed to convey an article, and the robot data 210 includes data of only the conveyance robot. When not only the conveyance robot but also a person conveys an article, data of the person who conveys the article may be included in the robot data 210. For example, the value of the type 212 can indicate that the article is conveyed by a person.

Returning to the description of the conveyance task management system 100 illustrated in FIG. 1.

The delay risk calculation unit 111 calculates a delay risk based on the probability density distribution of the conveyance time of the conveyance robot. The delay risk is a probability that the execution of the conveyance task by the conveyance robot is delayed from the delivery date 204 set in the task data 200 (i.e., a probability that the conveyance robot conveys the article beyond the delivery date 204 set for each conveyance task).

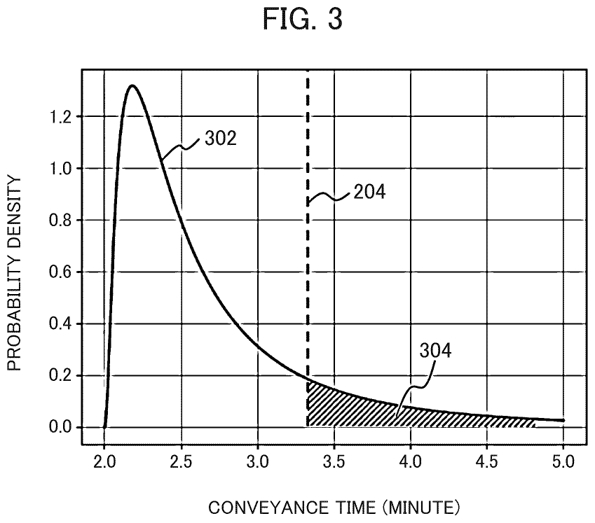

FIG. 3 is a diagram describing an example of the delay risk, and is a diagram illustrating a probability density distribution 302 of the conveyance time of the conveyance robot. The delay risk is a probability that the conveyance task by the conveyance robot is delayed. In the first embodiment, the delay risk is represented by the area of a region 304 in which the conveyance time exceeds the delivery date 204 in the probability density distribution 302 in which the horizontal axis represents the conveyance time and the vertical axis represents the value of a probability density. The probability density distribution 302 of the conveyance time is set for each combination of each task included in the task data 200 and each robot included in the robot data 210, and is stored in the delay risk calculation unit 111.

The delay risk calculation unit 111 calculates the delay risk by calculating the area of the region 304 using the probability density distribution 302 for each combination of each task and each robot.

The probability density distribution 302 of the conveyance time can be arbitrarily determined. FIG. 3 illustrates, as one example, an example in which the probability density distribution 302 is a log-normal distribution. The probability density distribution 302 may be a logarithmic distribution, an exponential distribution, a uniform distribution, or the like. Further, the probability density distribution 302 may be a distribution obtained by simulation or a distribution obtained from actual measurement data. For example, the delay risk calculation unit 111 can calculate the probability density distribution 302 by estimating, for the combination of each task of the task data 200 and each robot of the robot data 210, how long the conveyance time is when each robot tentatively performs each task, from a simulation result or actual measurement data.

An example in which the probability density distribution 302 of the conveyance time is a distribution obtained by simulation will be described in a second embodiment. An example in which the probability density distribution 302 of the conveyance time is a distribution obtained from the actual measurement data will be describe in a third embodiment.

Returning to the description of the conveyance task management system 100 illustrated in FIG. 1.

The task assignment unit 112 executes task assignment processing. The task assignment processing is processing of assigning a conveyance robot in the robot data 210 to each task indicated by the task data 200 so as to minimize the delay risk. The task assignment unit 112 can use any existing method such as a strict solution method, an approximate solution method, and an A* algorithm (A-star algorithm) to assign a conveyance robot to each task. In the present embodiment, a description will be made about an example in which the task assignment unit 112 uses a greedy method that is a kind of approximate solution method.

Hereinafter, the assignment of the conveyance robot to the task is referred to as task assignment.

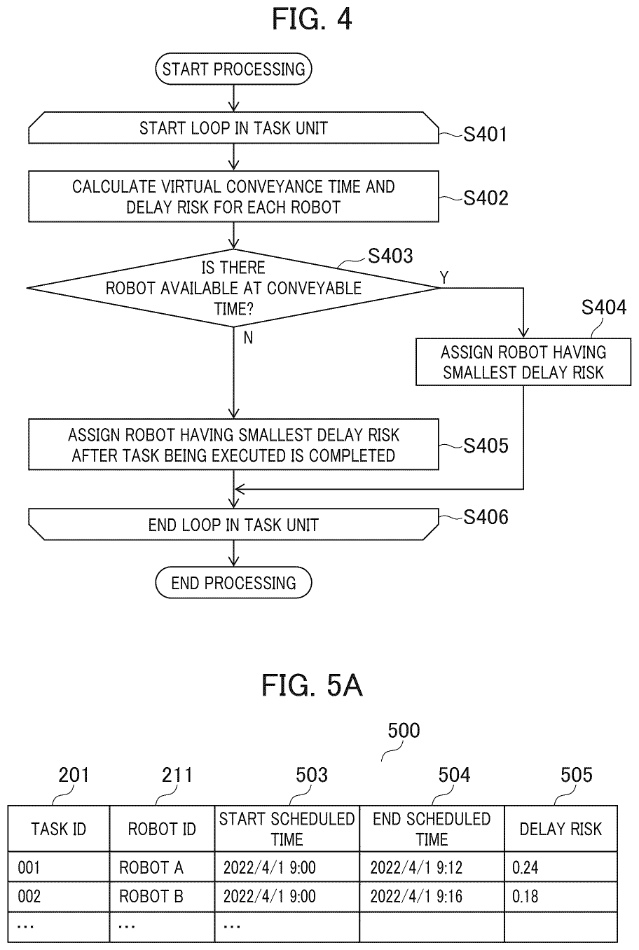

FIG. 4 is a diagram illustrating an example of a flowchart of processing in which the task assignment unit 112 assigns the conveyance robot to any one task using the greedy method. The task assignment unit 112 executes the processing illustrated in FIG. 4, and determines, for one task (assignment consideration task) for which assignment of the conveyance robot is being considered, a robot which executes this task.

In S401, the task assignment unit 112 starts a processing loop of FIG. 4 for each task. The task assignment unit 112 selects one task in accordance with the order of the conveyable time 203 or the delivery date 204 of the task data 200 of the conveyance data (FIG. 2), and starts the processing loop. The task selected in S401 is called the assignment consideration task.

In S402, the delay risk calculation unit 111 calculates a conveyance time (virtual conveyance time) in the case where it is assumed that each conveyance robot executes the assignment consideration task, and a delay risk in this case with respect to the robot in the robot data 210 of the conveyance data. The virtual conveyance time can be obtained using a representative value of the probability density distribution 302 of the conveyance time. The representative value is, for example, an average value or a median value. As described using FIG. 3, the delay risk can be obtained from the probability density distribution 302 of the conveyance time and the delivery date 204. The delay risk calculation unit 111 calculates a virtual conveyance time and a delay risk for each conveyance robot using an arbitrary method.

Incidentally, in the present embodiment, the delay risk calculation unit 111 calculates the virtual conveyance time and the delay risk for each conveyance robot using a path plan and conveyance simulation described in the second embodiment.

In S403, the task assignment unit 112 determines whether or not there is a robot available at the conveyable time 203 of the task data 200 for each robot in the robot data 210. If the robot is not executing any task at the conveyable time 203, the task assignment unit 112 determines that the robot is available. The task assignment unit 112 executes processing of S404 when there is a robot available at the conveyable time 203, and executes processing of S405 when there is no robot available at the conveyable time 203.

In S404, the task assignment unit 112 uses the delay risk calculated in S402 to assign a robot having the smallest delay risk among the available robots, to the assignment consideration task.

In S405, when the robot executes the assignment consideration task after the execution of the task executed at the conveyable time 203 is completed, the task assignment unit 112 assigns the robot having the smallest delay risk to the assignment consideration task.

In S406, the task assignment unit 112 ends the processing loop for one task (assignment consideration task) selected in S401.

The task assignment unit 112 and the delay risk calculation unit 111 execute the task assignment processing by performing the processing from S401 to S406 for all tasks. In the way described above, the robot having the smallest delay risk can be assigned to each task indicated by the task data 200.

Further, the delay risk calculation unit 111 may obtain delay risks for all the tasks indicated by the task data 200, and the task assignment unit 112 may assign the robots to the respective tasks so that the sum or the maximum value of the delay risks becomes the minimum.

Incidentally, in the present embodiment, there has been described an example in which the task assignment unit 112 executes a task assignment method using a greedy method (a method of assigning an available robot with the smallest delay risk to a task). The task assignment unit 112 may improve the task assignment obtained by the greedy method by using the task assignment obtained by the greedy method as an initial solution and further searching for a solution by using an approximate solution method such as a local search method or a method such as metaheuristics. Further, in the case where a sufficiently large amount of data of optimal task assignment is obtained, the task assignment unit 112 may execute task assignment using a method such as machine learning or deep learning.

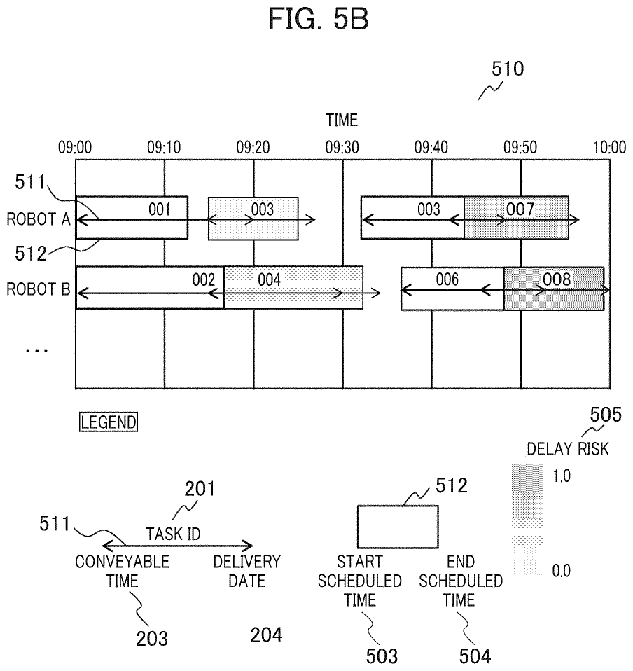

FIGS. 5A and 5B are diagrams illustrating an example in which a result of processing of assigning a robot to a task is output. The result of the processing of assigning the robot to the task is represented by, for example, task assignment result data 500 illustrated in FIG. 5A and a visualization display 510 of the task assignment result illustrated in FIG. 5B.

Hereinafter, the result of the task assignment unit 112 assigning the conveyance robot to each task, i.e., the result of the task assignment processing of the task assignment unit 112 is also referred to as a task assignment result.

The result output unit 113 of the conveyance task management system 100 (FIG. 1) outputs the task assignment result of the task assignment unit 112 to the output unit 122 of the input/output terminal 120. Specifically, the result output unit 113 outputs data used for the task assignment result data 500 and the visualization display 510 of the task assignment result. Further, the result output unit 113 outputs the delay risk obtained by the delay risk calculation unit 111 to the output unit 122.

The output unit 122 can display the task assignment result data 500 and the visualization display 510 of the task assignment result on the screen. The output unit 122 may display only the task assignment result data 500 on the screen. Further, the output unit 122 can display the delay risk on the screen.

The task assignment result data 500 illustrated in FIG. 5A includes the task ID 201, the robot ID 211, a start scheduled time 503, an end scheduled time 504, and a delay risk 505.

In the task assignment result data 500, the task ID 201 and the robot ID 211 of the conveyance robot assigned to the task represented by the task ID 201 are associated with each other.

As the value of the start scheduled time 503, the conveyable time 203 illustrated in FIG. 2 is used for the task to which the robot is allocated in the processing of S404 in FIG. 4, and the end scheduled time of the task being executed (e.g., the time indicated by the end scheduled time 504 in the task assignment result data 500) is used for the task to which the robot is allocated in the processing of S405.

The value of the end scheduled time 504 is obtained by adding an estimated time required for conveyance to the value of the start scheduled time 503. The estimated time required for conveyance can be calculated using a representative value (e.g., an average value or a median value) of the probability density distribution 302 of the conveyance time illustrated in FIG. 3.

The visualization display 510 of the task assignment result illustrated in FIG. 5B indicates task information and tasks assigned to the respective robots, with the horizontal axis representing time and the vertical axis representing the robot ID 211. In the visualization display 510 of the task assignment result, at least the conveyable time 203 and the delivery date 204 (task data 200 in FIG. 2) set for the task are shown as the task information. In the visualization display 510 of the task assignment result, a double-headed arrow line 511 and a box (horizontal bar) 512 are drawn for each robot. The double-headed arrow line 511 and the box 512 extend along the horizontal axis (time).

The double-headed arrow line 511 is a line with arrows at both ends, and indicates task information. As shown in the legend, the number above the double-headed arrow line 511 represents the task ID 201. The left end (the end at an earlier time) of the double-headed arrow line 511 represents the conveyable time 203. The right end (the end at a later time) of the double-headed arrow line 511 represents the delivery date 204.

The box 512 indicates the task assigned to the robot. As shown in the legend, the left end of the box 512 represents the start scheduled time 503. The right end of the box 512 represents the end scheduled time 504. The inside of the box 512 is colored to represent the delay risk 505. For example, as shown in the legend, the darker the color inside the box 512, the greater the delay risk 505. In the present embodiment, the magnitude of the delay risk 505 is indicated by the shade of color, but the magnitude of the delay risk 505 may be indicated by adding a color such as red or blue.

For example, a task with the task ID 201 of “001” is assigned to a robot with the robot ID 211 of “RobotA”, and as indicated by the box 512, the start scheduled time 503 of the task is 9:00, and the end scheduled time 504 is 9:12. In this task, as indicated by the double-headed arrow line 511, the conveyable time 203 is 9:00, and the delivery date 204 is 9:20.

Since the robot whose robot ID 211 is “RobotA” can finish the conveyance earlier than the delivery date 204, no delay occurs in the conveyance of an article. Also, in the robot whose robot ID 211 is “RobotB”, no delay occurs in the conveyance of an article. That is, in the present embodiment, the robot can be assigned to the task so that no delay occurs in the conveyance of the article.

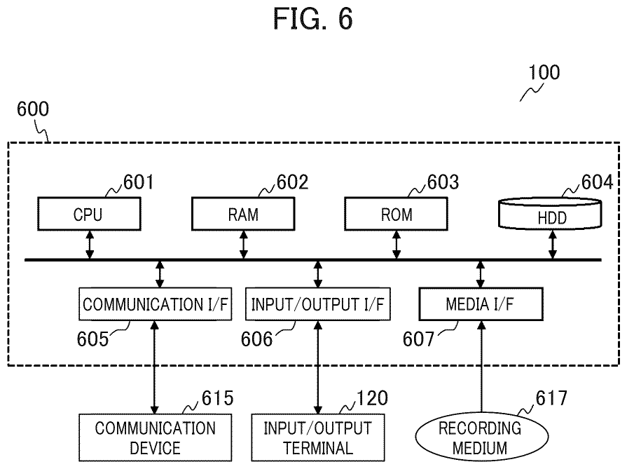

FIG. 6 is a diagram illustrating an example of a hardware configuration of the conveyance task management system 100 according to the present embodiment. The conveyance task management system 100 includes a computer 600 and an input/output terminal 120 being an input/output device, and is configured by connecting these to each other.

The computer 600 includes a CPU 601, a RAM 602, a ROM 603, an HDD 604, a communication interface 605, an input/output interface 606, and a media interface 607.

The communication interface 605 is connected to an external communication device 615. The input/output interface 606 is connected to the input/output terminal 120. The media interface 607 reads and writes data from and to a recording medium 617.

The CPU 601 executes a program (application software) read into the RAM 602 to control each processing unit of the arithmetic processing section 101 (FIG. 1). This program can be distributed via a communication line, or can be recorded on the recording medium 617 such as a CD-ROM and distributed.

In the conveyance task management system 100 and the conveyance task management method according to the present embodiment, as described above, the delay risk is calculated based on the probability density distribution 302 of the conveyance time of the conveyance robot, thereby making it possible to assign the robot to the task so as not to cause the delay in conveying the article. Therefore, for example, even if the conveyance time by the conveyance robot varies because the conveyance robot shares its movement space with the person, the delay of conveyance can be reduced.

### Second Embodiment

A conveyance task management system and a conveyance task management method according to a second embodiment of the present invention will be described. Hereinafter, the management system and the management method according to the present embodiment will be described focusing mainly on differences from the management system and the management method according to the first embodiment.

In the present embodiment, a description will be made about a configuration in which the probability density distribution 302 of the conveyance time is obtained by path planning and conveyance simulation. The delay risk calculation unit 111 calculates a delay risk using the probability density distribution 302 of the conveyance time obtained by the conveyance simulation.

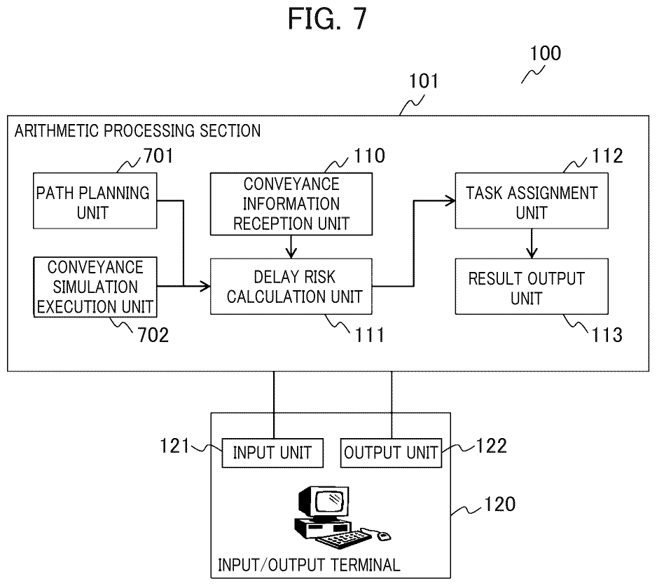

FIG. 7 is a diagram illustrating an example of a configuration of a conveyance task management system 100 according to the present embodiment. In the conveyance task management system 100 according to the present embodiment, the arithmetic processing section 101 further includes a path planning unit 701 and a conveyance simulation execution unit 702 in the conveyance task management system 100 (FIG. 1) according to the first embodiment.

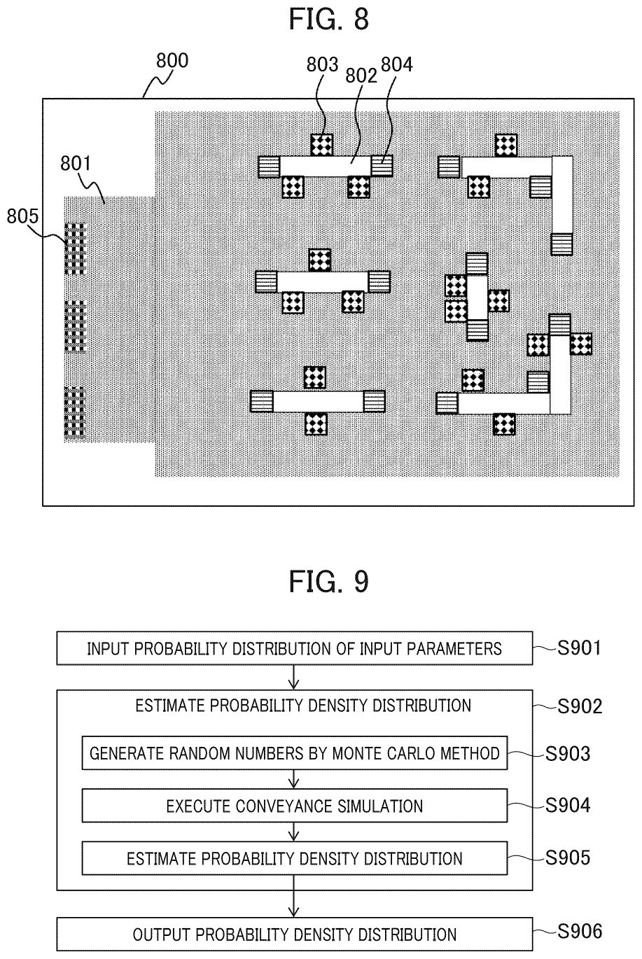

FIG. 8 is a diagram illustrating an example of a layout of a conveyance area 800 in which a conveyance robot executes a conveyance task. For example, when the conveyance area 800 is assumed to be a warehouse, the conveyance area 800 is divided into a plurality of areas 801 to 805. In FIG. 8, the conveyance area 800 is drawn and distinguished into a plurality of patterns, and ranges with the same pattern indicate the same type of area.

The area 801 indicates an area in which the conveyance robot and the person can move. In the example illustrated in FIG. 8, there is one type of movable area, but the movable area of the person and the movable area of the conveyance robot may be separated. The area 802 indicates an area of a manufacturing line. The area 803 indicates a work area of a worker. The area 804 indicates an area of a production cell. In the present embodiment, the area 804 of the production cell is the start point 205 or the end point 206 of the conveyance. The area 805 is an area of the component storage. In the present embodiment, the area 805 of the component storage is the start point 205 of the conveyance.

A value like Cell1-1 is given as an ID to the area 804 of the production cell, and a value like DeptA-1 is given as an ID to the area 805 of the component storage, respectively. These IDs correspond to the values of the start point 205 and the end point 206 of the task data 200 (FIG. 2).

The layout of the conveyance area 800 (e.g., the positions and sizes of the areas 801 to 805) is given in advance to the conveyance task management system 100 as layout information.

The path planning unit 701 and the conveyance simulation execution unit 702 execute path planning and conveyance simulation respectively, using the layout information of the conveyance area 800.

The path planning unit 701 plans, for each task indicated by the task data 200, a moving path of the conveyance robot from the start point 205 to the end point 206 of the task in accordance with a predetermined arbitrary evaluation index using the layout information of the conveyance area 800. For example, the path planning unit 701 obtains the moving path using an evaluation index indicating that the movement distance of the conveyance robot is the shortest. Any existing method such as the A* algorithm can be used for the path planning.

The path planning unit 701 outputs the planned moving path to the delay risk calculation unit 111. The moving path planned by the path planning unit 701 is used when the delay risk calculation unit 111 calculates the virtual conveyance time for each conveyance robot in S402 of FIG. 4. That is, in the present embodiment, in S402 of FIG. 4, the virtual conveyance time is obtained from the probability density distribution 302 of the conveyance time for the moving path planned by the path planning unit 701.

The conveyance simulation execution unit 702 performs conveyance simulation using the layout information of the conveyance area 800, and obtains the probability density distribution of the conveyance time for each conveyance robot using the moving path planned by the path planning unit 701 for each task indicated by the task data 200. In this conveyance simulation, the conveyance simulation execution unit 702 performs detailed simulation in consideration of congestion between robots or between a robot and a person inclusive of a conveyance robot and a person (for example, a conveyance worker or a person other than that) present in the conveyance area 800.

The conveyance simulation execution unit 702 uses, for example, the Monte Carlo method to obtain the probability density distribution of the conveyance time.

FIG. 9 is a diagram illustrating an example of a flowchart of processing in which the conveyance simulation execution unit 702 obtains the probability density distribution of the conveyance time using the Monte Carlo method.

In S901, the conveyance simulation execution unit 702 inputs the probability density distribution of each input parameter. The input parameter is a parameter which causes a variation in the conveyance time of the conveyance robot, and is mainly a parameter for a matter (e.g., a person, an object, and an environment) which affects the movement of the conveyance robot inside the conveyance area 800. For example, the conveyance simulation execution unit 702 assumes that the distribution of these input parameters is, for example, a normal distribution, and inputs the average and standard deviation of the normal distribution.

Examples of the input parameters include the number of persons, the moving speed of a person, the start and end points of movement of a person, the position of a person, the position of an object (an obstacle of a conveyance robot), a communication environment of the conveyance robot, and the brightness inside the conveyance area 800. When the conveyance robot is controlled by wireless communication, the conveyance time of the conveyance robot may depend on the communication environment. When the conveyance robot moves based on images captured by a camera, the conveyance time of the conveyance robot may be determined by the sharpness of an image, which depends on the brightness of the conveyance area 800.

In S902, the conveyance simulation execution unit 702 estimates the probability density distribution of the conveyance time. The processing of S902 is constituted of processing from S903 to S905.

In S903, the conveyance simulation execution unit 702 generates random numbers a predetermined number of times (e.g., 100 times) using the probability density distribution of the input parameters input in S901.

In S904, the conveyance simulation execution unit 702 executes conveyance simulation using the random numbers generated in S903 as input data. The conveyance simulation execution unit 702 calculates and obtains a conveyance time when an article is conveyed under the condition of an input parameter determined by a random number.

In S905, the conveyance simulation execution unit 702 estimates the probability density distribution of the conveyance time using the obtained conveyance time.

In S906, the conveyance simulation execution unit 702 outputs the estimated probability density distribution of the conveyance time to delay risk calculation unit 111.

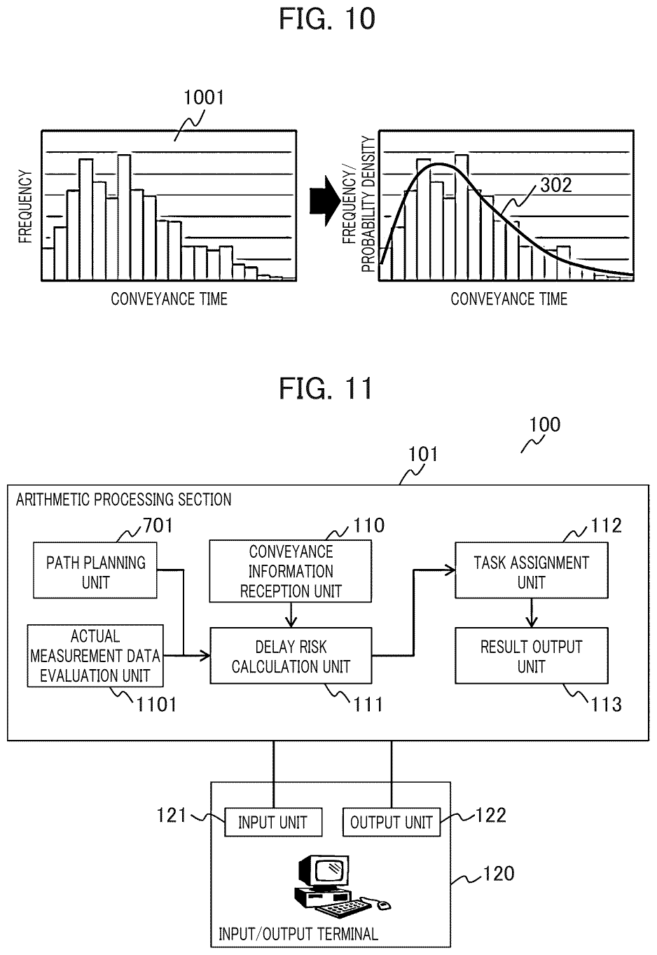

FIG. 10 is a diagram for describing an example of a method in which the conveyance simulation execution unit 702 estimates the probability density distribution of the conveyance time in S905 of FIG. 9. In FIG. 10, a histogram 1001 of the conveyance time is shown in the left drawing, and a probability density distribution 302 obtained from the histogram 1001 is shown in the right drawing.

The conveyance simulation execution unit 702 derives the histogram 1001 of the conveyance time using the obtained conveyance time. Then, the conveyance simulation execution unit 702 estimates the probability density distribution 302 of the conveyance time from the histogram 1001 by using a method such as KDE (Kernel density estimation).

Further, when it is assumed that the probability density distribution 302 of the conveyance time is a specific distribution (e.g., the log-normal distribution illustrated in FIG. 3), the conveyance simulation execution unit 702 can obtain parameters of this distribution using the least squares method or the like.

The delay risk calculation unit 111 calculates the delay risk in S402 of FIG. 4 by using the probability density distribution 302 of the conveyance time estimated as described above.

In the present embodiment, there has been described the example in which the path planning unit 701 executes the path planning and the conveyance simulation execution unit 702 executes the conveyance simulation. In the conveyance task management system 100 according to the present embodiment, the conveyance simulation execution unit 702 (or the path planning unit 701) may execute the path planning together with the conveyance simulation. Further, when the moving path of the conveyance robot is set in advance and fixed, the conveyance simulation may be executed using the moving path set in advance without executing the path planning.

Further, task assignment for assigning a robot to a task may be executed as follows. The path planning is first executed to obtain the moving path of the conveyance robot, and a probability density distribution of an appropriate conveyance time is assumed. The task assignment unit 112 temporarily assigns the robot to the task using the moving path and the probability density distribution of the conveyance time. The conveyance simulation execution unit 702 executes conveyance simulation using the task assignment result generated by the task assignment unit 112, and obtains a probability density distribution of the conveyance time. The task assignment unit 112 executes task assignment again using the probability density distribution of the conveyance time obtained by the conveyance simulation.

In the present embodiment, since the probability density distribution 302 of the conveyance time is obtained by the conveyance simulation having considered the parameters affecting the movement of the conveyance robot, and the delay risk is calculated using the obtained probability density distribution 302, the delay risk can be obtained more accurately, and the delay of conveyance can be further reduced.

### Third Embodiment

A conveyance task management system and a conveyance task management method according to a third embodiment of the present invention will be described. Hereinafter, the management system and the management method according to the present embodiment will be described focusing mainly on differences from the management system and the management method according to the second embodiment.

In the present embodiment, a description will be made about a configuration in which the probability density distribution 302 of the conveyance time is obtained from actual measurement data. The delay risk calculation unit 111 calculates a delay risk using the probability density distribution 302 of the conveyance time obtained from the actual measurement data.

FIG. 11 is a diagram illustrating an example of a configuration of a conveyance task management system 100 according to the present embodiment. In the conveyance task management system 100 according to the present embodiment, the arithmetic processing section 101 does not have the conveyance simulation execution unit 702 and includes an actual measurement data evaluation unit 1101, in the conveyance task management system 100 according to the second embodiment (FIG. 7).

In the present embodiment, it is assumed that data when the conveyance robot actually executes the conveyance task is actual measurement data, and the actual measurement data is sufficiently present. The actual measurement data includes at least one of the conveyance time of the article by the conveyance robot in the conveyance experiment performed in advance and the conveyance time when the conveyance robot actually conveys the article, in the moving path planned by the path planning unit 701. Note that the actual measurement data is data of the conveyance time when the conveyance robot conveys the article in the conveyance area 800 in which the person and the conveyance robot are actually mixed.

Of the processing illustrated in FIG. 9, the actual measurement data evaluation unit 1101 executes the processing of estimating the probability density distribution 302 of the conveyance time in S905 and the processing of outputting the probability density distribution 302 of the conveyance time in S906 to the delay risk calculation unit 111.

The actual measurement data evaluation unit 1101 stores the actually measured data therein. Similarly to the conveyance simulation execution unit 702 according to the second embodiment, the actual measurement data evaluation unit 1101 derives the histogram 1001 (FIG. 10) of the conveyance times from the conveyance times included in the actual measurement data and obtains the probability density distribution 302 of the conveyance time for the moving path planned by the path planning unit 701 with respect to each task indicated by the task data 200 in the processing of S905 in FIG. 9.

However, in the case where a plurality of pieces of substantially the same actual measurement data are obtained from a plurality of different states (e.g., in the case where there is a variation in the number of persons, the moving speed, or the like even when the actual measurement data are substantially the same), the probability density distribution 302 of the conveyance time can be estimated using the actual measurement data in the state to be evaluated among the plurality of pieces of actual measurement data. In this case, for example, the probability density distribution 302 of the conveyance time may be estimated using a machine learning method such as a random forest.

Fourth Embodiment A conveyance task management system and a conveyance task management method according to a fourth embodiment of the present invention will be described. Hereinafter, the management system and the management method according to the present embodiment will be described focusing mainly on differences from the management system and the management method according to the first embodiment.

In the present embodiment, a description will be made about a configuration in which the number of conveyance robots that conveys an article is optimized using a result of assigning a conveyance robot to a task (task assignment result). The optimization of the number of conveyance robots can be performed, for example, in a preliminary examination of conveyance.

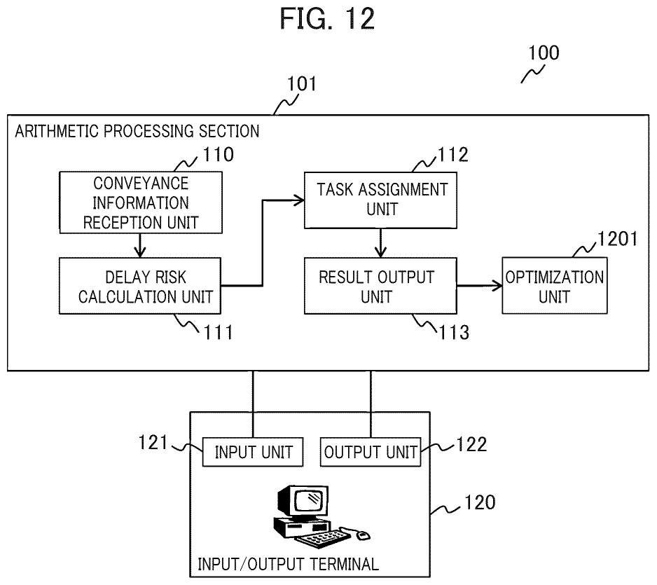

FIG. 12 is a diagram illustrating an example of a configuration of a conveyance task management system 100 according to the present embodiment. In the conveyance task management system 100 according to the present embodiment, the arithmetic processing section 101 further includes an optimization unit 1201 in the conveyance task management system 100 (FIG. 1) according to the first embodiment.

The task assignment unit 112 performs the task assignment processing (FIG. 4) plural times while changing the number of conveyance robots.

Each time the number of conveyance robots changes (i.e., for each of the numbers of conveyance robots), the optimization unit 1201 derives an evaluation index related to the delay risk 505 from the task assignment result of the task assignment unit 112. The evaluation index is an index determined in advance to set the delay risk 505 to an allowable value, and can be set to, for example, a maximum value, an average value, or the like of the delay risks 505 of all the tasks. In the present embodiment, the maximum value of all the delay risks 505 is assumed to be the evaluation index.

The optimization unit 1201 obtains the relationship between the number of conveyance robots and the evaluation index, i.e., how the evaluation index changes when the number of conveyance robots changes.

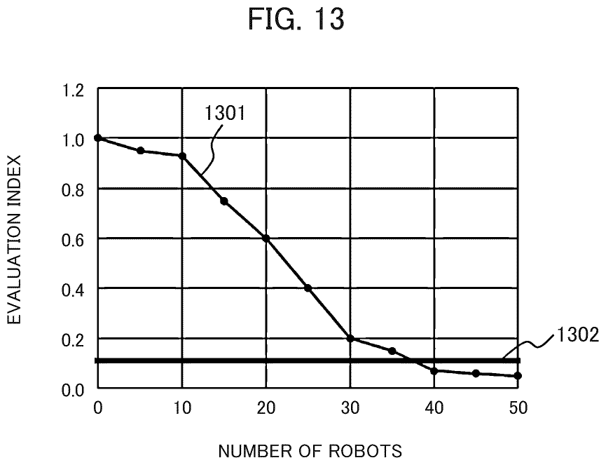

FIG. 13 is a diagram illustrating an example of the relationship between the number of conveyance robots and an evaluation index 1301, which is obtained by the optimization unit 1201. In the example illustrated in FIG. 13, the evaluation index 1301 is the maximum value of all delay risks 505. There is shown in FIG. 13, a relationship in which the evaluation index 1301 is reduced as the number of conveyance robots increases.

FIG. 13 also illustrates a threshold value 1302 predetermined for the evaluation index 1301. The threshold value 1302 can be arbitrarily determined according to the evaluation index 1301 and the task.

The optimization unit 1201 compares the derived evaluation index 1301 with the threshold value 1302. The number of conveyance robots for which the evaluation index 1301 is greater than or equal to the threshold value 1302 or less than or equal to the threshold value 1302 is the preferred number of conveyance robots. Then, the minimum or maximum number among the preferred numbers of conveyance robots can be set as the optimum number of conveyance robots. In this way, the optimization unit 1201 can obtain the optimum number of conveyance robots using the evaluation index 1301.

In the example illustrated in FIG. 13, since the evaluation index 1301 is the maximum value of the delay risk 505, the number of conveyance robots for which the evaluation index 1301 is less than or equal to the threshold value 1302 is the preferred number of conveyance robots. Then, the minimum number of conveyance robots among the preferred number of conveyance robots is the optimum number of conveyance robots. In the example illustrated in FIG. 13, the preferred number of conveyance robots is 37 or more, and the optimum number of conveyance robots is 37.

As described above, the optimization unit 1201 can obtain and optimize the number of conveyance robots required to set the delay risk to an allowable value.

Note that the optimization unit 1201 may not only optimize the number of conveyance robots, but also execute various processing such as optimization of the layout of the conveyance area 800, optimization of the conveyance amount to be conveyed at a time, and consideration of the arrangement of parts delivery persons (persons who load/unload to/from the conveyance robot) as the preliminary consideration of conveyance by using the task assignment result.

In the present embodiment, as an example, a description will be briefly made about an example in which the optimization unit 1201 optimizes the layout (FIG. 8) of the conveyance area 800 using the task assignment result of the task assignment unit 112.

The task assignment unit 112 performs the task assignment processing (FIG. 4) plural times while changing the layout of the conveyance area 800.

The optimization unit 1201 derives the evaluation index each time the layout of the conveyance area 800 changes (that is, for each layout of the conveyance area 800), and obtains the relationship between the layout and the evaluation index, that is, how the evaluation index changes as the layout changes. Then, the optimization unit 1201 compares the derived evaluation index and the threshold value with each other, and obtains a preferable layout or an optimal layout. For example, a layout in which the evaluation index 1301 is greater than or equal to the threshold value 1302 or less than or equal to the threshold value 1302 can be set as a preferable layout, and a layout in which the evaluation index 1301 is the minimum or the maximum among the preferable layouts can be set as an optimal layout.

The change of the layout includes, for example, a change of a position of an article to be conveyed (a position of a component storage), a change of a position of a production facility (a position of a production cell), and a change of a position of an object existing in the conveyance area 800.

In the conveyance task management system and the conveyance task management method according to the present embodiment, as described above, the number of conveyance robots, the layout of the conveyance area 800, and the like can be optimized using the task assignment result.

### Fifth Embodiment

A conveyance task management system and a conveyance task management method according to a fifth embodiment of the present invention will be described. Hereinafter, the management system and the management method according to the present embodiment will be described focusing mainly on differences from the management system and the management method according to the first embodiment.

In the present embodiment, a description will be made about a configuration in which the task assignment processing (FIG. 4) is dynamically executed and used for control of the conveyance robot. Dynamically executing the task assignment processing refers to assigning a conveyance robot to a task in accordance with the task execution status of the conveyance robot.

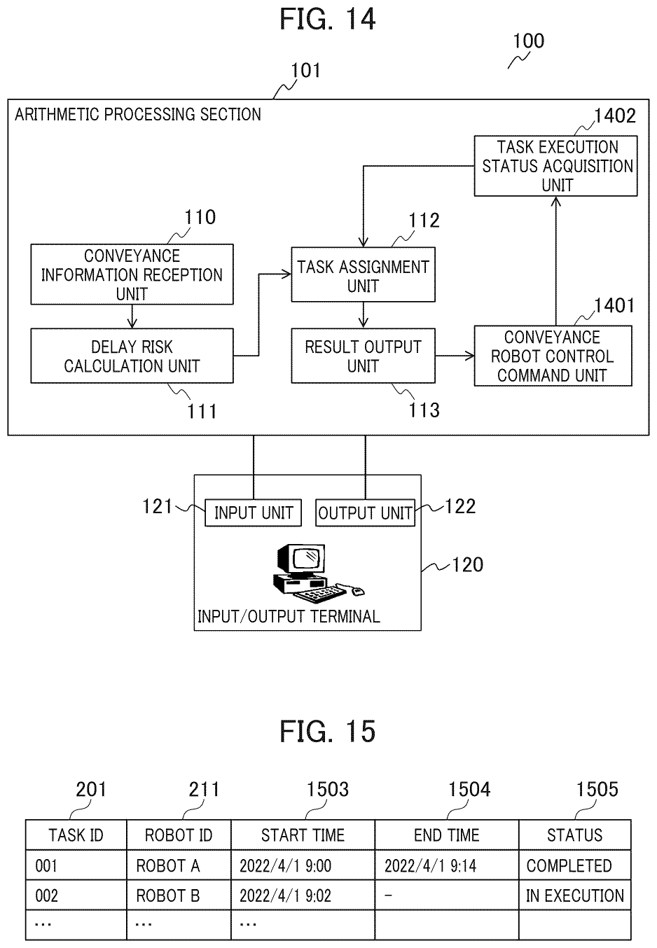

FIG. 14 is a diagram illustrating an example of a configuration of a conveyance task management system 100 according to the present embodiment. In the conveyance task management system 100 according to the present embodiment, the arithmetic processing section 101 further includes a conveyance robot control command unit 1401 and a task execution status acquisition unit 1402 in the conveyance task management system 100 (FIG. 1) according to the present embodiment.

The conveyance robot control command unit 1401 gives a control command to the conveyance robot, based on the task assignment result of the task assignment unit 112, and causes the conveyance robot to execute the task.

The task execution status acquisition unit 1402 acquires task execution status data from the conveyance robot. The task execution status data includes the execution status of the task of the conveyance robot, i.e., whether or not the conveyance robot to which the control command is given has actually executed the task, the start and end times of the executed task, and the like.

FIG. 15 is a diagram illustrating an example of the task execution status data. The task execution status data includes a task ID 201, a robot ID 211, a start time 1503, an end time 1504, and a status 1505. The start time 1503 is a start time of the task when the conveyance robot with the robot ID 211 executes the task with the task ID 201. The end time 1504 is an end time of the task when the conveyance robot with the robot ID 211 executes the task with the task ID 201. The status 1505 indicates the state of the task. For example, a task with the task ID 201 of 001 is completed, and a task with a task ID 201 of 002 is not recorded with an end time and is in execution.

The task assignment unit 112 dynamically executes the task assignment processing (FIG. 4). In the present embodiment, a description will be made about an example in which the task assignment unit 112 executes the task assignment processing at a predetermined time interval (e.g., an interval of 10 minutes), and an example in which the task assignment processing is executed at a required point of time.

First, a description will be made about the case where the task assignment processing is executed at the predetermined time interval. The task execution status acquisition unit 1402 acquires the task execution status data from the conveyance robot at this time interval. The task assignment unit 112 acquires the task execution status data from the task execution status acquisition unit 1402, executes the task assignment processing, based on the execution status of the task of the conveyance robot at this point of time (e.g., the status 1505 or the time from the start time 1503 to the current time) and the command of the task from the MES or the like, for example, in the same manner as in the first embodiment or the second embodiment, and assigns the robot to the task. The task assignment unit 112 can obtain a scheduled time at which a robot which is actually available or a robot which is executing a task ends the task, and the like from the execution status of the task of the conveyance robot included in the acquired task execution status data

Next, a description will be made about the case where the task assignment processing is executed at the required point of time. The task assignment unit 112 executes, for example, task assignment processing for one day in advance. The task execution status acquisition unit 1402 acquires the execution status of the task of the conveyance robot at any timing. The task assignment unit 112 re-executes the task assignment processing according to the task execution status data acquired from the task execution status acquisition unit 1402. With the task execution status data, it is possible to know whether the task is delayed, whether the task has been executed, and the like.

For example, the task assignment unit 112 compares the task execution status of the conveyance robot acquired by the task execution status acquisition unit 1402 with a predetermined task plan. Then, in the case where the execution status of the task deviates from the previous plan, the task assignment unit 112 re-executes the task assignment processing and re-assigns the robot to the task.

For example, when the execution status of the task deviates from the previous plan by more than a predetermined threshold value, the task assignment unit 112 determines that the execution status of the task deviates from the previous plan. Further, the task assignment unit 112 may re-execute the task assignment processing in the case where the command of the task from the MES or the like is changed from the previous command due to a change in the production plan or the like and is input anew, etc.

Further, the conveyance task management system 100 according to the present embodiment includes the conveyance simulation execution unit 702 (FIG. 7) described in the second embodiment, and can dynamically execute the task assignment processing. In this case, the conveyance simulation execution unit 702 performs the conveyance simulation in advance under the condition that various situations related to the execution of the task such as the number of persons are assumed, to obtain the probability density distribution 302 of the conveyance time, and stores the obtained probability density distribution 302 of the conveyance time in a database. The delay risk calculation unit 111 calculates the delay risk using the probability density distribution 302 obtained in the situation closest to the current situation in the probability density distributions 302 of the conveyance times stored in the database. When done in this way, the delay risk can be calculated more accurately by reflecting the actual situation.

Further, when executing the task assignment processing in real time in accordance with the execution status of the task, the conveyance simulation execution unit 702 may perform conveyance simulation while reflecting the actual execution status of the task (e.g., the execution status of the task of the conveyance robot acquired by the task execution status acquisition unit 1402) to obtain the probability density distribution 302 of the conveyance time. In this case, when a sensor capable of acquiring the situation of the conveyance area 800, such as a human flow measurement sensor is used, the situation of the conveyance area 800 is reproduced by simulation, so that the probability density distribution 302 of the conveyance time closer to the reality can be obtained, and the delay risk can be calculated more accurately.

It should be noted that the present invention is not limited to the embodiments described above, and includes various modification examples. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments. In addition, the configuration of one embodiment can also be added with the configurations of other embodiments. In addition, part of the configuration 4 each of the embodiments can be deleted, and subjected to addition and replacement with respect to other configurations.

In addition, each configuration of the conveyance task management system according to the present invention may be realized by hardware by designing some or all of these by, for example, an integrated circuit, and the like. In addition, some or all of these may be realized by software by causing a processor to interpret and execute a program which realizes each function. Information such as a program, a table, a file, measured information, and calculated information for realizing each function can be recorded in recording devices such as a memory, a hard disk drive, and an SSD (Solid State Drive), or recording media such as an IC card, an SD card, and a DVD. Therefore, each configuration of the control device according to the present invention can realize each function as a processing section, a processing unit, a program module, and the like.

Further, in each drawing, control lines and information lines are descried as being necessary for description. It does not necessarily list all of the control lines and information lines necessary for a product. In an actual product, it may be considered that almost all components are connected to each other.

Furthermore, communication means for connecting the respective devices is not limited to a wired LAN or a wireless LAN, and may be changed to other communication means.

### LIST OF REFERENCE SIGNS

100 . . . conveyance task management system, 101 . . . arithmetic processing section, 110 . . . conveyance information reception unit, 111 . . . delay risk calculation unit, 112 . . . task assignment unit, 113 . . . result output unit, 120 . . . input/output terminal, 121 . . . input unit, 122 . . . output unit, 200 . . . task data, 201 . . . task ID, 202 . . . conveyance article ID, 203 . . . conveyable time, 204 . . . delivery date, 205 . . . start point, 206 . . . end point, 210 . . . robot data, 211 . . . robot ID, 212 . . . type, 213 . . . standard speed, 214 . . . initial position, 302 . . . probability density distribution, 304 . . . region in which conveyance time becomes time which exceeds delivery date, 500 . . . task assignment result data, 503 . . . start scheduled time, 504 . . . end scheduled time, 505 . . . delay risk, 510. visualization display of task assignment result, 511 . . . double-headed arrow line, 512 . . . box, 600 . . . computer, 601 . . . CPU, 602 . . . RAM, 603 . . . ROM, 604 . . . HDD, 605 . . . communication interface, 606 . . . input/output interface, 607 . . . media interface, 615 . . . communication device, 617 . . . recording medium, 701 . . . path planning unit, 702 . . . conveyance simulation execution unit, 800 . . . conveyance area, 801 to 805 . . . area, 1001 . . . histogram, 1101 . . . actual measurement data evaluation unit, 1201 . . . optimization unit, 1301 . . . evaluation index, 1302 . . . threshold value, 1401 . . . conveyance robot control command unit, 1402 . . . task execution status acquisition unit, 1503 . . . start time, 1504 . . . end time, 1505 . . . status

1. A conveyance task management system comprising:
a conveyance information reception unit configured to input task information related to a conveyance task and robot information related to a robot that executes the conveyance task;
a delay risk calculation unit configured to calculate a delay risk that is a probability that the conveyance task by the robot is delayed;
a task assignment unit configured to execute task assignment processing that is processing of assigning the robot included in the robot information to the conveyance task included in the task information so that the delay risk is minimized; and
a result output unit configured to output a task assignment result which is a result of the task assignment processing.

2. The conveyance task management system according to claim 1, wherein
delay risk calculation unit calculates the delay risk based on a probability density distribution of the conveyance time of the robot, and
the probability density distribution is set for each combination of the conveyance task included in the task information and the robot included in the robot information.

3. The conveyance task management system according to claim 2, including:
a path planning unit configured to plan a movement path of the robot for the conveyance task; and
a conveyance simulation execution unit which performs simulation and obtains the probability density distribution for the conveyance task by using the movement path planned by the path planning unit, wherein
the delay risk calculation unit calculates the delay risk based on the probability density distribution obtained by the conveyance simulation execution unit.

4. The conveyance task management system according to claim 2, including:
a path planning unit configured to plan a movement path of the robot for the conveyance task; and
an actual measurement data evaluation unit which stores actual measurement data when the robot actually executes the conveyance task, and obtains the probability density distribution from the conveyance time included in the actual measurement data for the movement path planned by the path planning unit for the conveyance task, wherein
the delay risk calculation unit calculates the delay risk based on the probability density distribution obtained by the actual measurement data evaluation unit.

5. The conveyance task management system according to claim 1, wherein
the delay risk calculation unit obtains the delay risk for all the conveyance tasks included in the task information, and
the task assignment unit assigns the robot to the conveyance task so that a sum or a maximum value of the delay risks is minimized.

6. The conveyance task management system according to claim 2, wherein
the delay risk calculation unit obtains the conveyance time by using a representative value of the probability density distribution.

7. The conveyance task management system according to claim 1, including
an optimization unit which obtains an optimal number of the robots, wherein
the task assignment unit performs the task assignment processing plural times while changing the number of the robots, and
the optimization unit derives an evaluation index related to the delay risk for each of the number of the robots and obtains an optimal number of the robots using the evaluation index.

8. The conveyance task management system according to claim 1, including
an optimization unit configured to optimize a layout of a conveyance area in which the robot executes the conveyance task, wherein
the task assignment unit performs the task assignment processing plural times while changing the layout, and
the optimization unit derives an evaluation index related to the delay risk for each of the layouts, and obtains the optimal layout using the evaluation index.

9. The conveyance task management system according to claim 1, including:
a control command unit configured to give a control command to the robot, based on the task assignment result; and
a task execution status acquisition unit configured to acquire, from the robot, task execution status data including an execution status of the conveyance task of the robot.

10. The conveyance task management system according to claim 9, wherein
the task execution status acquisition unit acquires the task execution status data from the robot at predetermined time intervals, and
the task assignment unit acquires the task execution status data from the task execution status acquisition unit and executes the task assignment processing based on the acquired task execution status data.

11. The conveyance task management system according to claim 9, wherein
the task execution status acquisition unit acquires the task execution status data from the robot, and
the task assignment unit acquires the task execution status data from the task execution status acquisition unit and executes the task assignment processing according to the acquired task execution status data.

12. The conveyance task management system according to claim 1, including
an input/output terminal having a screen, wherein
the input/output terminal displays the task assignment result and the delay risk on the screen.

13. A conveyance task management method that is executed by a conveyance task management system having an arithmetic processing section, the conveyance task management method comprising:
a conveyance data input step of inputting by the arithmetic processing section, task information related to a conveyance task and robot information related to a robot that executes the conveyance task;
a delay risk calculation step of calculating by the arithmetic processing section, a delay risk that is a probability that the conveyance task by the robot is delayed;
a task assignment step of executing by the arithmetic processing section, task assignment processing that is processing of assigning the robot included in the robot information to the conveyance task included in the task information so that the delay risk is minimized; and
a result output step of outputting by the arithmetic processing section, a task assignment result that is a result of the task assignment processing.

14. The conveyance task management method according to claim 13, wherein
in the delay risk calculation step, the arithmetic processing section calculates the delay risk based on a probability density distribution of the conveyance time of the robot, and
the probability density distribution is set for each combination of the conveyance task included in the task information and the robot included in the robot information.
